(19) United States
(12) Patent Application Publication
(10) Pub. No.: US 2017/0192818 A1
(43) Pub. Date: Jul. 6, 2017

(54) MATRIX DIVISION METHOD AND PARALLEL PROCESSING APPARATUS

(71) Applicant: FUJITSU LIMITED, Kawasaki-shi (JP)

(72) Inventor: Koichi Shimizu, Inagi (JP)

(73) Assignee: FUJITSU LIMITED, Kawasaki-shi (JP)

(21) Appl. No.: 15/372,921

(22) Filed: Dec. 8, 2016

(30) Foreign Application Priority Data
Jan. 4, 2016 (JP) 2016-000151

(51) Int. Cl. G06F 9/48; G06F 9/52

(52) U.S. Cl. CPC G06F 9/4881; G06F 9/52

(57) ABSTRACT

There is provided a matrix division method used by a computer that performs processing for computing a matrix equation including a sparse matrix as a coefficient matrix. The matrix division method includes acquiring, from a storing unit, a threshold used to determine the multitude of non-zero elements included in each of rows of the sparse matrix; identifying, within the sparse matrix, a first row whose count of non-zero elements is larger than the threshold; extending the sparse matrix by dividing the identified first row into a plurality of second rows; and dividing the extended sparse matrix into a plurality of row groups and assigning a process being an executable unit of the processing to each of the row groups.

### CROSS-REFERENCE TO RELATED APPLICATION

This application is based upon and claims the benefit of priority of the prior Japanese Patent Application No. 2016-000151, filed on Jan. 4, 2016, the entire contents of which are incorporated herein by reference.

### FIELD

The embodiments discussed herein are related to a matrix division method and a parallel processing apparatus.

### BACKGROUND

Numerical simulations based on analytical schemes, such as structural analyses, fluid analyses, and electromagnetic field analyses, are employed in designing structures, electronic circuits, and the like. Many of equations defining the physical laws of analysis objects are expressed as partial differential equations dealing with continuous physical quantities. Therefore, in numerical simulations, problems for solving partial differential equations are replaced by problems for solving matrix equations using a discretization method, such as a finite element method (FEM).

The coefficient matrix of such a matrix equation is a high-dimensional large-scale sparse matrix in which most of the elements are zero. Therefore, in order to reduce computational load and the memory usage, an iterative method is used which keeps modifying the solution to the matrix equation until the correct solution is found by repeated computation. Examples of iterative methods include the conjugate gradient (CG) method; the bi-conjugate gradient (BiCG) method; the conjugate residual (CR) method; the conjugate gradient squared (CGS) method; and the incomplete Cholesky conjugate gradient (ICCG) method.

There are disclosed techniques for enabling high-speed magnetic field analyses and structural analyses using finite element methods and iterative methods. There is also a disclosed technique for preparing the Cholesky method (a type of direct method) and the ICCG method (a type of iterative method) to solve simultaneous linear equations. According to this technique, either the Cholesky method or the ICCG method is used depending on whether the count of non-zero elements included in a stiffness matrix falls within the range that fits in memory of a computer.

Japanese Laid-open Patent Publication No. 2010-122850

Japanese Laid-open Patent Publication No. 2005-207900

Japanese Laid-open Patent Publication No. 5-73527

Japanese Laid-open Patent Publication No. 2012-204835

In the case of employing an iterative method, a plurality of processes (each being an executable unit of computing processing) are run in parallel by dividing a coefficient matrix into a plurality of row groups (sets of rows) and assigning each of the processes to a different row group. If the coefficient matrix is a band matrix whose non-zero elements are confined to the diagonal and a few of the immediately adjacent diagonals, there is less imbalance in operation load among the processes. On the other hand, if the coefficient matrix includes some rows having a significantly larger number of non-zero elements compared to others, each process assigned to a row group including many non-zero elements acts as a bottleneck and slows down the entire parallel processing.

For example, in the case where a magnetic field produced by an electric current flowing through a conductor when a voltage is applied to a part of the conductor is analyzed using a finite element method and an iterative method, the vector potential component and the current component in each finite element are unknowns. A region corresponding to the vector potential component within the coefficient matrix is defined by the connectivity among the finite elements, and non-zero elements are, therefore, confined to the diagonal and a few of the immediately adjacent diagonals. On the other hand, as for coefficients corresponding to the current component, many finite elements have non-zero values. As a result, each row of matrix elements corresponding to the current component includes many non-zero elements. In the case of a structural analysis, rows with a great number of non-zero elements appear when constraint conditions are added.

In parallel processing, execution results obtained from one process are used in different processes. Therefore, a process falling behind in its operation is not able to pass its operation results on to other processes, thus causing a delay in the entire processing. That is, the process falling behind in its operation acts as a bottleneck and slows down the entire processing. The processing power preferably increases in a linear fashion as a function of the number of processes executable in parallel (the parallel process count). However, under conditions where such a bottleneck is present, very little increase in the processing power takes place with increasing parallel process count once the parallel process count exceeds a certain number.

### SUMMARY

According to one embodiment, there is provided a non-transitory computer-readable storage medium storing a matrix computing program that causes a processor of a computer including memory and the processor to perform a procedure. The computer performs processing for computing a matrix equation that includes a sparse matrix as a coefficient matrix. The procedure includes acquiring, from the memory, a threshold used to determine the multitude of non-zero elements included in each of rows of the sparse matrix; identifying, within the sparse matrix, a first row whose count of non-zero elements is larger than the threshold; extending the sparse matrix by dividing the identified first row into a plurality of second rows; and dividing the extended sparse matrix into a plurality of row groups and assigning a process being an executable unit of the processing to each of the row groups.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a parallel processor according to a first embodiment;

FIG. 2 illustrates an example of hardware (a single device) according to a second embodiment;

FIG. 3 illustrates an example of hardware (multiple devices) according to the second embodiment;

FIG. 4 is a block diagram illustrating an example of functions of an information processor according to the second embodiment;

FIG. 5 illustrates a structure of a matrix equation and a pseudocode implementing an ICCG method;

FIG. 6 illustrates another structure of the matrix equation and a pseudocode implementing a parallel ICCG method;

FIG. 7 illustrates an example of a matrix extension method according to the second embodiment;

FIG. 8 illustrates an example of a region division method according to the second embodiment;

FIG. 9 illustrates a pseudocode implementing the parallel ICCG method according to the second embodiment;

FIG. 10 is a first diagram illustrating a flow of processing performed by the information processor according to the second embodiment;

FIG. 11 is a second diagram illustrating the flow of processing performed by the information processor according to the second embodiment;

FIG. 12 illustrates a data structure of a matrix information piece according to the second embodiment;

FIG. 13 illustrates a data structure of a communication information piece according to the second embodiment;

FIG. 14 illustrates how to create a coefficient matrix (connectivity of nodes) according to an application example of the second embodiment;

FIG. 15 illustrates how to create a coefficient matrix (to which current unknowns have been added) according to the application example of the second embodiment;

FIG. 16 illustrates an example of a matrix extension method and a region division method according to the application example of the second embodiment;

FIG. 17 illustrates a setting example of matrix information pieces according to the application example of the second embodiment;

FIG. 18 illustrates non-zero patterns of a column vector for individual CPUs according to the application example of the second embodiment;

FIG. 19 illustrates data copies among the CPUs according to the application example of the second embodiment;

FIG. 20 illustrates a setting example of communication information pieces according to the application example of the second embodiment;

FIG. 21 illustrates a program code example of a Share function according to the second embodiment;

FIG. 22 illustrates a program code example for plugging in results of matrix-vector multiplication and a program code example of a Reduce sum function according to the second embodiment;

FIG. 23 illustrates evaluation results of parallel scalability achieved by applying a technique of the second embodiment;

FIG. 24 illustrates a program code example of a DistCoilPa function according to the second embodiment; and

FIG. 25 illustrates an example of calculating degrees of freedom assigned, based on outputs of the DistCoilPa function according to the second embodiment.

### DESCRIPTION OF EMBODIMENTS

Several embodiments will be described below with reference to the accompanying drawings. In the following description and the accompanying drawings, like reference numerals refer to like elements having substantially the same functions, and a repeated description thereof may be omitted.

### (a) First Embodiment

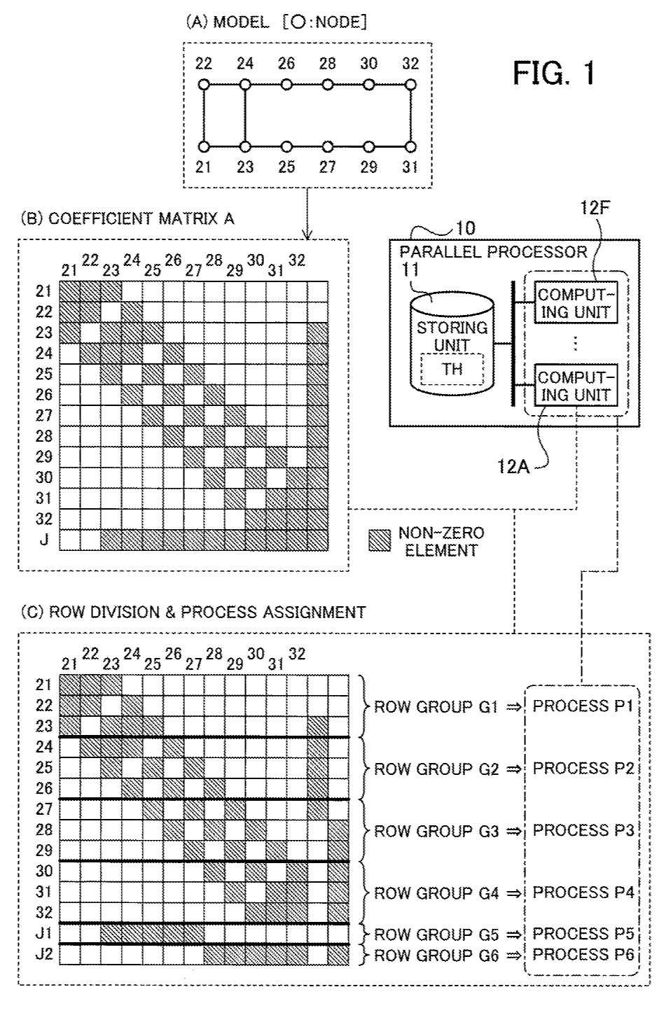

A first embodiment is described next with reference to FIG. 1. FIG. 1 illustrates an example of a parallel processor according to the first embodiment. Note that a parallel processor 10 of FIG. 1 is an example of a parallel processor according to the first embodiment. The first embodiment is directed to a method for solving a matrix equation problem whose coefficient matrix is a sparse matrix, and provides a parallel processing method for efficiently processing the problem by assigning a plurality of processes, each being an executable unit of computing processing, to sub-regions of the coefficient matrix and running the processes in parallel.

As for some patterns of non-zero elements (non-zero patterns) included in a coefficient matrices, no improvement in the processing speed is observed with increasing parallel process count once the parallel process count exceeds a certain number. That is, there are non-zero patterns that reduce the scalability of the parallel processing. The first embodiment provides a technique for improving the scalability of the parallel processing even in the case of dealing with a coefficient matrix including such a non-zero pattern.

As illustrated in FIG. 1, the parallel processor 10 includes a storing unit 11 and computing units 12A to 12F. Note that the number of computing units is here six (the computing units 12A to 12F) for the purpose of illustration; however, two or more computing units may be used. In addition, the parallel processor 10 may be a computer, a set of computers housed in a single chassis, or a distributed processing system in which a plurality of computers are connected via communication lines.

The storing unit 11 is a volatile storage device, such as random access memory (RAM), or a non-volatile storage device, such as a hard disk drive (HDD) or flash memory. The computing units 12A to 12F are processors, such as central processing units (CPUs) or digital signal processors (DSPs). In addition, some of the computing units 12A to 12F may be general-purpose computing on graphics processing units (GPGPUs). The computing units 12A to 12F execute a program stored in the storing unit 11 or different memory. The computing units 12A to 12F are able to run a plurality of processes in parallel. The term process here means an executable unit of computing processing. For example, the computing units 12A to 12F are able to run Processes P1 to P6, respectively, in parallel. The example of FIG. 1 illustrates that the parallel processor 10 performs processing for computing a matrix equation which includes a coefficient matrix A. The coefficient matrix A is a sparse matrix including a small number of non-zero elements and a great number of zero elements (see (B) of FIG. 1).

As for a finite element model illustrated in (A) of FIG. 1, its non-zero pattern based on the connectivity of nodes, each of which is assigned one of node numbers 21 to 32, is defined as the pattern of non-zero elements within the coefficient matrix A of (B) of FIG. 1, with the exclusion of the lowermost row and rightmost column. For example, in the case of a structural analysis, a displacement vector or internal force vector is assigned to each node, and unknowns are set for the individual nodes. With the setting of unknowns, a structural object (continuous body) is discretized at the nodes. Herewith, the behavior of a physical quantity given by a partial differential equation is described by a discretized matrix equation. As boundary conditions are set in solving a partial differential equation, constraint conditions are added, i.e., known values are set for the physical quantity of some of the nodes, in solving a matrix equation.

The constraint conditions above result in the coefficient matrix A with rows and columns each including a great number of non-zero elements (see the lowermost row and rightmost column in the coefficient matrix A of (B) of FIG. 1). Therefore, in the case of dividing the coefficient matrix A with the non-zero pattern illustrated in (B) of FIG. 1 into a plurality of row groups and assigning a process to each of the row groups, some processes may have to deal with a significantly larger number of non-zero elements compared to other processes (note that the number of non-zero elements dealt with by each process corresponds to the operation load of the process). In this condition, increasing the number of processes and then the number of divisions of the coefficient matrix A creates further operation load imbalance among the processes. These problems are not specific to structural analyses and may also be seen in electromagnetic field analyses.

In order to correct the above-described operation load imbalance, the parallel processor 10 divides each row with a great number of non-zero elements in the coefficient matrix A. In this regard, the storing unit 11 stores therein a threshold TH used to determine the multitude of non-zero elements included in each row of the sparse matrix. The threshold TH is set in advance, for example, according to the number of rows in the coefficient matrix A and the width of a band consisting of non-zero elements (band region) confined to the diagonal and a few of the immediately adjacent diagonals.

For example, the computing unit 12A identifies, within the sparse matrix (coefficient matrix A), a first row J whose number of non-zero elements exceeds the threshold TH. In addition, the computing unit 12A divides the first row J into two second rows J1 and J2 to thereby extend the sparse matrix, as illustrated in (C) of FIG. 1. In the example of (C) of FIG. 1, the sparse matrix (coefficient matrix A) is extended by one row and column on the lower and right sides, respectively, of the sparse matrix. The computing unit 12A divides the extended sparse matrix (coefficient matrix A) into Row Groups G1 to G6 and, then, assigns a process to each of Row Groups G1 to G6.

In the example of (C) of FIG. 1, Processes P1 to P6 are assigned to Row Groups G1 to G6, respectively. The computing units 12A to 12F run Processes P1 to P6 assigned to Row Groups G1 to G6 in parallel. For example, the computing units 12A to 12F perform Processes P1 to P6 (computing operations individually corresponding to each of Row Groups G1 to G6), respectively. Iterative methods such as the ICCG method, for example, are used to solve matrix equations. In the case of applying the ICCG method, the computing units 12A to 12F individually compute, for example, the matrix-vector multiplication (the product of a matrix and a vector) corresponding to Row Groups G1 to G6.

By dividing each row with a great number of non-zero elements and then dividing the coefficient matrix A into a plurality of row groups according to the number of non-zero elements as described above, it is possible to almost equally distribute operation load of the processes assigned to the individual row groups. As a result, it is less likely to cause a slowdown in the operations of some processes due to relative delays in the operations of other processes, which in turn circumvents the restrictions on the scalability attributed to the operation load imbalance. The first embodiment has been described thus far.

### (b) Second Embodiment

Next described is a second embodiment. The second embodiment is directed to a method for solving a matrix equation problem whose coefficient matrix is a sparse matrix, and provides a parallel processing method for efficiently processing the problem by assigning a plurality of processes, each being an executable unit of computing processing, to sub-regions of the coefficient matrix and executing the processes in parallel. The parallel processing method provides a technique for appropriately dividing the coefficient matrix to prevent imbalance in the operation load distribution across the processes and improve the scalability of the parallel processing.

b-1. Hardware

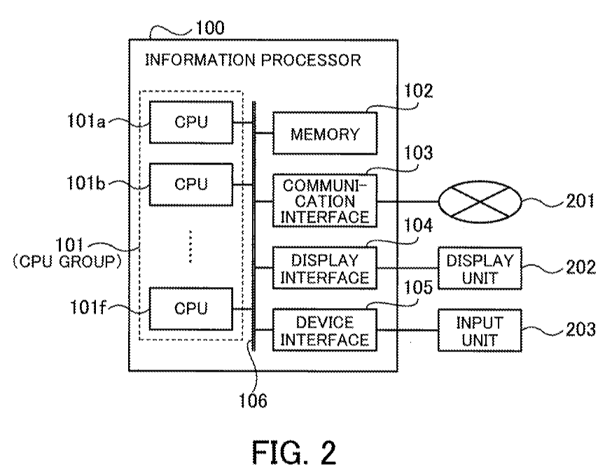

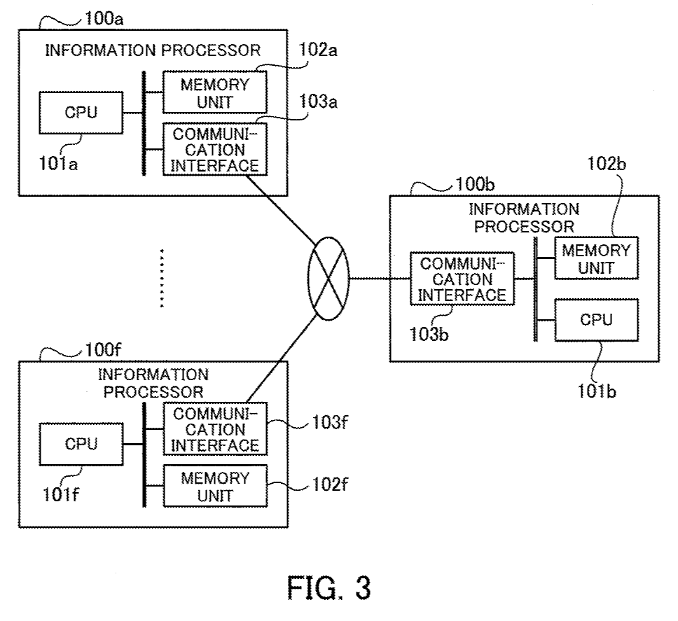

Next described is hardware of an information processor capable of implementing the parallel processing method according to the second embodiment, with reference to FIGS. 2 and 3. An information processor 100 illustrated in FIG. 2 and information processors 100a to 100f illustrated in FIG. 3 are examples of the information processor capable of implementing the parallel processing method according to the second embodiment.

FIG. 2 illustrates an example of hardware (a single device) according to the second embodiment. The information processor 100 includes a CPU group 101, memory 102, a communication interface 103, a display interface 104, and a device interface 105. The CPU group 101 includes CPUs 101a, 101b, . . . , and 101f. The CPUs 101a, 101b, . . . , and 101f, the memory 102, the communication interface 103, the display interface 104, and the device interface 105 are connected to each other via a bus 106. Note here that the number of CPUs included in the CPU group 101 is not limited to six as in this example, and may be any number equal to two or more.

The CPUs 101a, 101b, . . . , and 101f function, for example, as computing or control units and control all or part of the operations of the hardware elements based on various programs stored in the memory 102. Each of the CPUs 101a, 101b, . . . , and 101f may include a plurality of processor cores. Note that the CPU group 101 may include one or more GPGPUs. The memory 102 is an example of storage device for temporarily or permanently storing, for example, a program to be loaded into the CPUs 101a, 101b, . . . , and 101f, data to be used for their computation, and various parameters that vary when the program is executed. The memory 102 may be a volatile storage device, such as RAM, or a non-volatile storage device, such as a HDD or flash memory.

The communication interface 103 is a communication device used to connect with a network 201. The communication interface 103 is, for example, a wired or wireless local area network (LAN) communication circuit or an optical communication circuit. The network 201 is a network connected with a wire or wirelessly, and is, for example, the Internet or a LAN. The display interface 104 is a connection device used to connect to a display unit 202. The display unit 202 is, for example, a cathode ray tube (CRT), a liquid crystal display (LCD), a plasma display panel (PDP), or an electro-luminescence display (ELD). The device interface 105 is a connection device used to connect to an external device, such as an input unit 203. The device interface 105 is, for example, a universal serial bus (UBS) port, an IEEE 1394 port, a small computer system interface (SCSI), or an RS-232C port. To the device interface 105, a removable storage medium (not illustrated) or an external device, such as a printer, may be connected. The removable storage medium is, for example, a magnetic disk, an optical disk, a magneto-optical disk, or a semiconductor memory.

A computing method according to the second embodiment is implemented using the single information processor 100 provided with a plurality of CPUs as illustrated in FIG. 2; however, the technique of the second embodiment may be applied to a distributed processing system as illustrated in FIG. 3. FIG. 3 illustrates an example of hardware (multiple devices) according to the second embodiment. According to the example of FIG. 3, the CPUs 101a, 101b, . . . , and 101f are individually installed on information processors 100a, 100b, . . . , and 100f, respectively. Then, the information processors 100a, 100b, . . . , and 100f are connected to each other via a communication line.

Each of memory units 102a, 102b, . . . , and 102f is the same as the memory 102 described above. Each of communication interfaces 103a, 103b, . . . , and 103f are the same as the communication interface 103 described above. Note that hardware components corresponding to the display interface 104 and the device interface 105 are not illustrated in each of the information processors 100a, 100b, . . . , and 100f for the purpose of illustration. The information processors 100a, 100b, . . . , and 100f are able to operate as a distributed processing system for performing computing operations distributed across the CPUs 101a, 101b, . . . , and 101f by sending and receiving results of the computing operations to and from each other.

The computing method according to the second embodiment is implemented by using the hardware of the information processor 100 of FIG. 2 or the distributed processing system of FIG. 3. Note that the hardware configurations illustrated in FIGS. 2 and 3 are merely examples, and the technique of the second embodiment may be applied to, for example, a system for causing a plurality of GPGPUs or CPU cores to operate in parallel to thereby run a plurality of processes in parallel. Next described is an example of using the information processor 100 of FIG. 2 for the purpose of illustration. The hardware configurations have been described thus far.

b-2. Functions

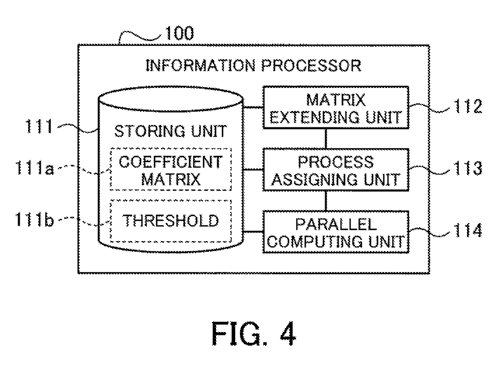

Next described are functions of the information processor 100 with reference to FIG. 4. FIG. 4 is a block diagram illustrating an example of the functions of the information processor according to the second embodiment.

As illustrated in FIG. 4, the information processor 100 includes a storing unit 111, a matrix extending unit 112, a process assigning unit 113, and a parallel computing unit 114. The function of the storing unit 111 is implemented, for example, using the memory 102. The functions of the matrix extending unit 112 and the process assigning unit 113 are implemented, for example, using the CPU 101a. The function of the parallel computing unit 114 is implemented, for example, using a plurality of CPUs (for example, all or some of the CPUs 101a to 101f) included in the CPU group 101.

The storing unit 111 stores therein a coefficient matrix 111a and a threshold 111b. The coefficient matrix 111a is a coefficient matrix included in a matrix equation subject to the computing processing. For example, in the case of solving a matrix equation “Ax=b” which includes vectors b and x and a coefficient matrix A, the information of the coefficient matrix A is stored in the storing unit 111. In this case, information on the vector b (the right-side vector) is also stored in the storing unit 111. The threshold 111b is used to determine the multitude of non-zero elements in each row of the coefficient matrix 111a (i.e., to determine whether the non-zero count of each row of the coefficient matrix 111a is large). The threshold is set, for example, according to the size of the coefficient matrix A and the number of processes (each being an executable unit of the computing processing) executed by the information processor 100 in parallel.

The matrix extending unit 112 counts the number of non-zero elements (the non-zero count) included in each row of the coefficient matrix A, and identifies rows whose non-zero count exceeds the threshold. Then, the matrix extending unit 112 divides each of the identified rows into a plurality of rows to thereby extend the coefficient matrix A. That is, the matrix extending unit 112 breaks up each row with high non-zero count into a plurality of rows with low non-zero count.

The process assigning unit 113 divides the coefficient matrix A extended by the matrix extending unit 112 into a plurality of row groups according to the number of processes to be executed by the information processor 100 in parallel. Note that each of the row groups is a set of one or more rows. Then, the process assigning unit 113 assigns a process to each of the row groups. The parallel computing unit 114 causes a plurality of CPUs (some or all of the CPUs 101a to 101f) included in the CPU group 101 to execute the processes assigned to the individual row groups.

### APPLICATION EXAMPLE

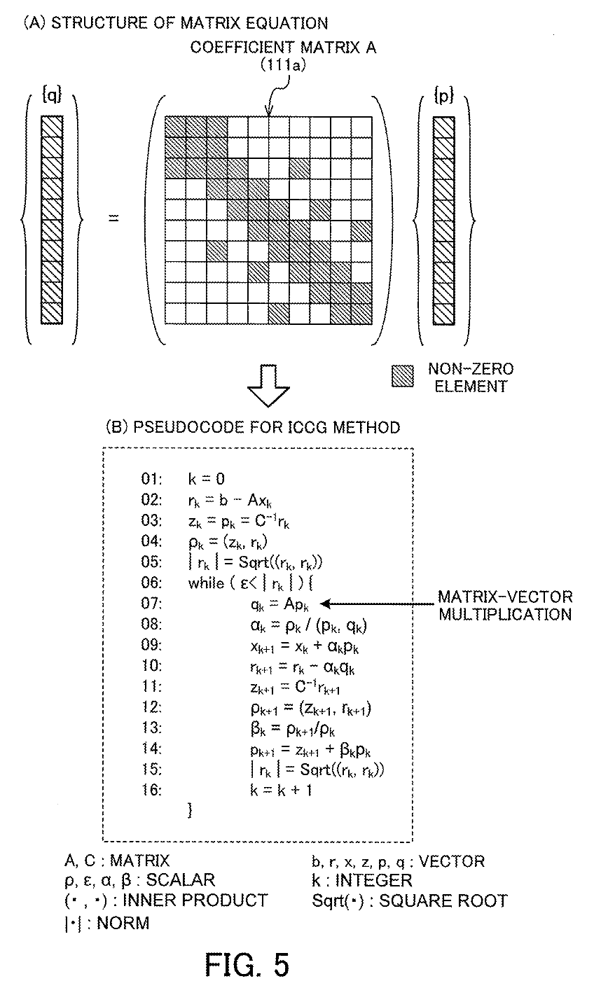

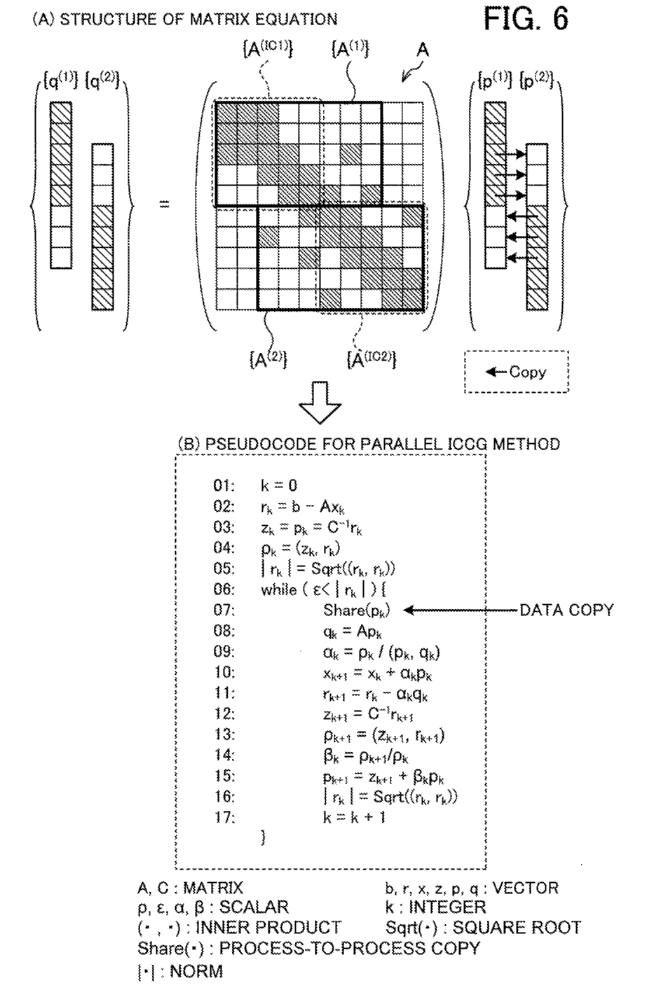

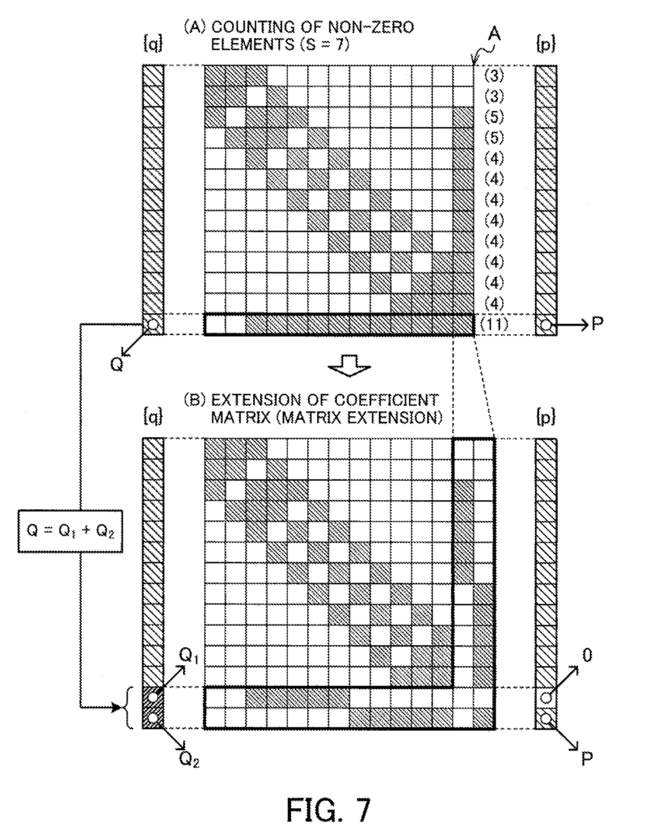

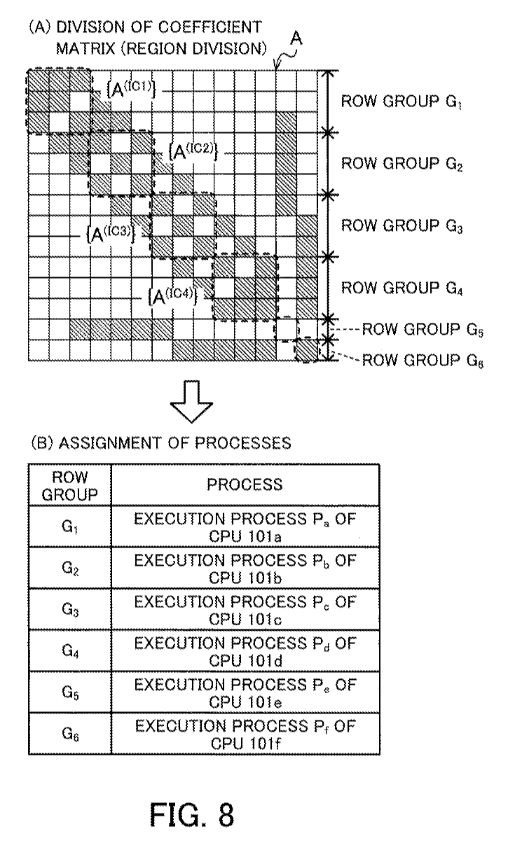

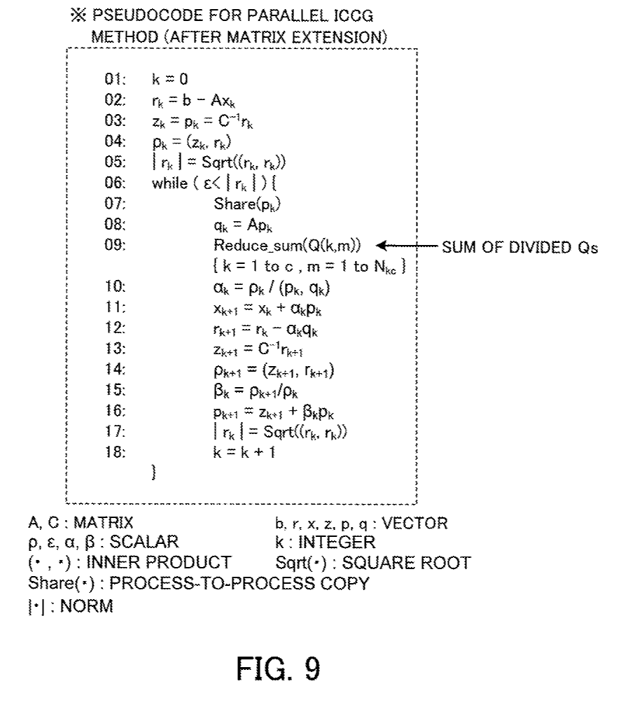

Next described is a method for applying the technique of the second embodiment to a calculation algorithm for solving a matrix equation using the ICCG method, with reference to FIGS. 5 to 9. Note that the ICCG method here is used only as an example, and the technique of the second embodiment is applicable to solving a matrix equation using an iterative method other than the ICCG method. FIG. 5 illustrates the structure of a matrix equation and a pseudocode implementing the ICCG method. FIG. 6 illustrates another structure of the matrix equation and a pseudocode implementing a parallel ICCG method. FIG. 7 illustrates an example of a matrix extension method according to the second embodiment. FIG. 8 illustrates an example of a region division method according to the second embodiment. FIG. 9 illustrates a pseudocode implementing the parallel ICCG method according to the second embodiment.

The ICCG method is a hybrid computation scheme that combines preprocessing called an incomplete Cholesky (IC) decomposition with the conjugate gradient (CG) method. For example, in the case where a matrix A is a target matrix, the matrix A is decomposed using a diagonal matrix D and an off-diagonal matrix L, as expressed by Equation (1) below. In this regard, the diagonal matrix D and the off-diagonal matrix L are obtained by Equations (2) and (3), respectively.

$$\begin{matrix}( \begin{matrix}{A}_{11} & {A}_{12} & & {A}_{1 n} \\ {A}_{21} & {A}_{22} & & \\ ⋮ & & ⋮ & \\ {A}_{n 1} & & & {A}_{nn}\end{matrix} ) = ( \begin{matrix}1 & & & 0 \\ {L}_{21} & 1 & & ⋮ \\ ⋮ & & ⋮ & \\ {L}_{n 1} & {L}_{n 2} & & 1\end{matrix} ) ( \begin{matrix}{D}_{11} & & & 0 \\ & {D}_{22} & & \\ & & ⋮ & \\ 0 & & & {D}_{nn}\end{matrix} ) ( \begin{matrix}1 & {L}_{21} & ⋮ & {L}_{n 1} \\ & 1 & & {L}_{n 2} \\ & & ⋮ & ⋮ \\ 0 & & & 1\end{matrix} ) & ( 1 ) \\ {D}_{ii} = {A}_{ii} - {\sum }_{k = 1}^{i - 1} {L}_{ik} {D}_{kk} {L}_{ik} & ( 2 ) \\ {L}_{ij} = ( {A}_{ij} - {\sum }_{k = 1}^{j - 1} {L}_{ik} {D}_{kk} {L}_{jk} ) / {D}_{jj} & ( 3 )\end{matrix}$$

The incomplete Cholesky decomposition is a scheme for calculating a matrix C (C=LDL^{T}≈A) under the restriction that “the arrangement pattern of non-zero elements (non-zero pattern) included in the off-diagonal matrix L is the same as the non-zero pattern of the matrix A″. Note that the superscript T refers to the matrix transpose. Placing such a restriction offers the advantage of being able to determine in advance the size of an array for storing values of the off-diagonal matrix L. In addition, the ICCG method has the advantage of being able to reduce the computational load and memory usage in the case where the coefficient matrix A is a sparse matrix, like one illustrated in (A) of FIG. 5.

A pseudocode for the ICCG method to solve the matrix equation “Ax=b” which includes the vectors b and x and the coefficient matrix A is given in (B) of FIG. 5, for example. Note here that A and C are matrices. b, r, x, z, p, and q each with an index k, or the like, are vectors. ρ, ε, α, and β each with the index k, or the like, are scalars. k is an integer. (•, •) is an inner product of two vectors. Sgrt(•) represents the square root of a vector. |•| is a norm representing the size of a vector. Numeric characters, such as 1, given on the left-hand side of the pseudocode are line numbers.

By executing the pseudocode of (B) of FIG. 5, the solution (approximate solution) for the vector x is obtained. The computation of “qₖ=Apₖ” in Line 7 of the pseudocode includes the multiplication of the matrix A and the vector pₖ (matrix-vector multiplication) in the right side of the equation. Such matrix-vector multiplication involves high computational load. Therefore, how effectively to carry out the matrix-vector multiplication has an effect on reducing the operation load and time.

In view of this, a method is employed which divides the coefficient matrix A into a plurality of sub-regions (for example, {A⁽¹⁾} and {A⁽²⁾}), as illustrated in (A) of FIG. 6, and assigns the operation of each sub-region to a different CPU to thereby achieve parallel processing (parallel ICCG method). Note that, in the case of applying the incomplete Cholesky decomposition, the non-zero elements in block regions ({A^{(IC1)}} and {A^{(IC2)}}), each surrounded by the dashed line in (A) of FIG. 6, are used in the operation.

(B) of FIG. 6 illustrates the pseudocode for the parallel ICCG method. Line 7 of the pseudocode includes the implementation of the Share(•) function. The Share(•) function is used to allow a CPU in charge of the operation of a sub-region to send part of its computational results to a different CPU and also receive, among computational results obtained by a different CPU, results to be used for its own computation. That is, the Share(•) function is called to allow a plurality of CPUs that perform their operations in parallel to share data (computational results) to be used in the respective operations of the individual CPUs. For example, the pseudocode of (B) of FIG. 6 includes the computation of inner products in Lines 9, 13, and 16. The computation of these inner products needs data calculated by different CPUs. Therefore, steps of data exchanges using the Message Passing Interface (MPI) functions are inserted into the pseudocode. Note that a program code example of the Share(•) function is given later.

The coefficient matrix A illustrated in (A) of FIG. 6 is a band matrix whose non-zero elements are confined to the diagonal and a few of the immediately adjacent diagonals. In this case, it is possible to achieve load distribution by dividing the coefficient matrix A into a plurality of row groups (two row groups in the example of FIG. 6) each including more or less the same number of non-zero elements. However, as illustrated in FIG. 7, in the case where a row whose non-zero count is considerably larger (the lowermost row in the example of (A) of FIG. 7) than those of other rows is present in the coefficient matrix A, sufficient load distribution may not be achieved if the pseudocode of (B) of FIG. 6 is directly applied to this case without any change.

In (A) of FIG. 7, each numeric character given on the right-hand side of the coefficient matrix A (such as (3), (3), . . . , and (11)) indicates the non-zero count of the corresponding row. In the case of dividing the coefficient matrix A into three row groups, for example, it is possible to organize the three groups in such a manner that each of the groups includes more or less the same number of non-zero elements. This allows three CPUs to share nearly equal operation load, and it is therefore expected that the processing power would be improved commensurate with the parallel process count (3 in this case).

On the other hand, in the case of dividing the coefficient matrix A with the total number of rows amounting to 13 into ten row groups, the created row groups include a row group including 11 (or more) non-zero elements and row groups each including about 5 or so non-zero elements. As described above, the computation of a CPU in charge of one row group needs computational results obtained by another CPU in charge of a different row group. This means that a CPU in charge of a row group with a low non-zero count waits for a different CPU in charge of a row group with a high non-zero count to produce computational results. That is, improvement in the processing power commensurate with the parallel process count (10 in this case) is unlikely to be achieved.

In view of the above, according to the second embodiment, the matrix extending unit 112 identifies a row whose non-zero count exceeds a threshold S (for example, S=7) (such a row is referred to as a “large row”) and divides the large row into a plurality of rows each with a low non-zero count, as illustrated in (B) of FIG. 7. In this regard, the matrix extending unit 112 also divides a column (the rightmost column in the example of (B) of FIG. 7) so that the coefficient matrix A after the division becomes a symmetric matrix.

In addition, the matrix extending unit 112 extends the vectors {p} and {q} corresponding to the large row. For example, in the case where an element of the vector {q} corresponding to the large row is Q, Q₁ and Q₂ are defined as elements individually corresponding to each of the rows created by the division. Note here that Q=Q₁+Q₂. In the case where an element of the vector {p} corresponding to the large row is P, the values of elements corresponding to the rows created by the division depend on the placement of a non-zero element. In the example of (B) of FIG. 7, the non-zero element in the lower right corner of the coefficient matrix A is assigned to the extreme right in the lower row created by the division. In this case, an element of the vector {p} corresponding to the bottommost row after the division is P while an element of the vector {p} corresponding to the row immediately above the bottommost row is 0.

By extending the coefficient matrix A in the above-described manner, it is possible to divide the coefficient matrix A into a plurality of row groups in consideration of the balance of the non-zero counts, as illustrated in (A) of FIG. 8. In the example of (A) of FIG. 8, the coefficient matrix A is divided into Row Groups G1 to G6. Note that in the case of applying the ICCG method, the process assigning unit 113 refers to the extent of non-zero elements used for the computation (i.e., the extent surrounded by the dashed line in (A) of FIG. 8) and determines the size of the row groups in consideration of the number of non-zero elements included in the extent. Then, the process assigning unit 113 assigns each of the row groups to a different process. In the example of (B) of FIG. 8, Row Groups G1 to G6 are assigned to Execution Processes Pₐ to P_{f}, respectively.

FIG. 9 illustrates the pseudocode for the parallel ICCG method, in consideration of processing associated with the extension of the coefficient matrix A (matrix extension) of (B) of FIG. 7. In the case where the coefficient matrix A is extended, the element Q of the vector {q} corresponding to the large row is also divided. Therefore, a step of calculating the sum of the divided elements (Q₁ and Q₂ in the example above) is added. In the pseudocode of FIG. 9, the Reduce_sum(•) function in Line 09 implements the step of calculating the sum of the elements.

Note here that c is the number of large rows included in the coefficient matrix A; N_{kc} is the parallel process count (the number of processes executed in parallel); and Q(k, m) is the m^{th} divided element obtained by dividing an element of the vector {q} corresponding to the k^{th} large row. For example, according to the example of (B) of FIG. 7, c is 1, and Q₁ corresponds to Q(1, 1) and Q2 corresponds to Q(1, 2). According to the example of FIG. 8, N_{kc} is 6. The functions of the information processor 100 have been described thus far.

b-3. Flow of Processing

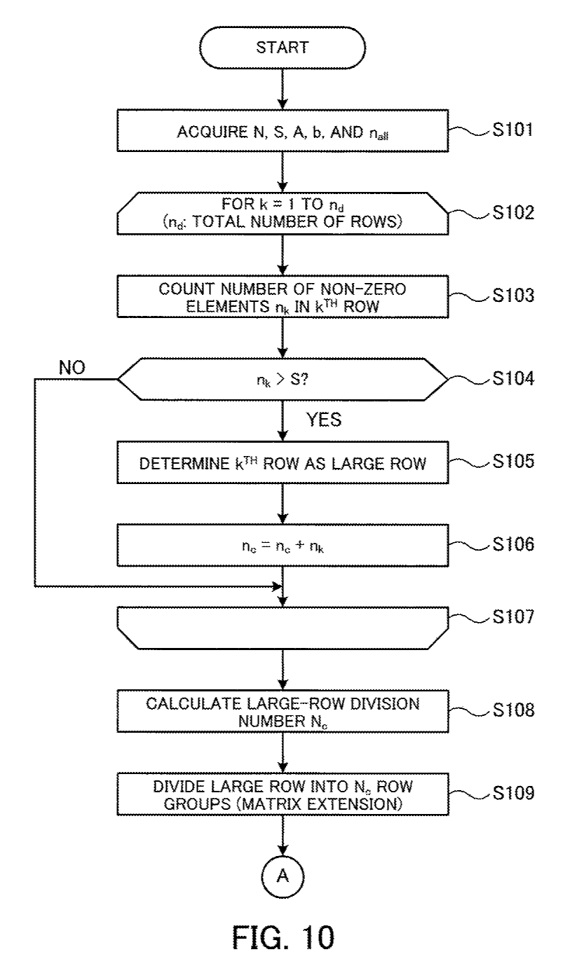

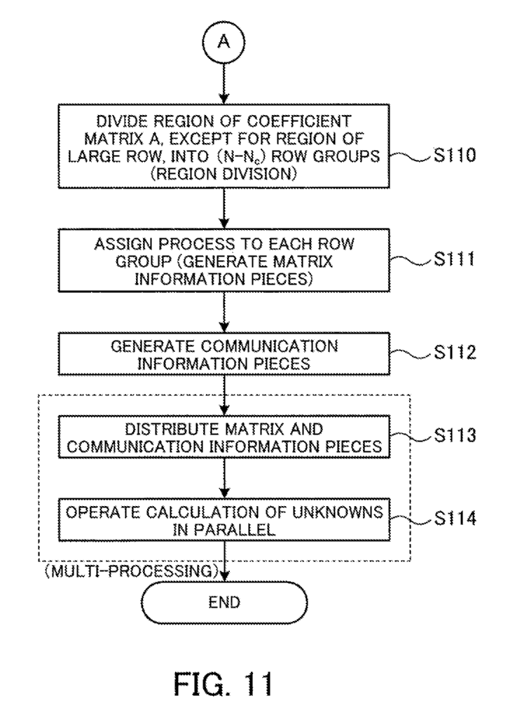

Next described is the flow of processing performed by the information processor 100 to solve the matrix equation “Ax=b” which includes the vectors b and x and the coefficient matrix A, with reference to FIGS. 10 and 11. FIG. 10 is a first diagram illustrating the flow of processing performed by the information processor according to the second embodiment. FIG. 11 is a second diagram illustrating the flow of processing performed by the information processor according to the second embodiment.

[Step S101] The matrix extending unit 112 acquires a parallel process count N, the threshold S, the coefficient matrix A, the right-side vector b, and a total count of non-zero elements nₐₗₗ. The parallel process count N is the number of processes to be used in the parallel processing, and corresponds to the number of CPUs in the case of assigning each of the processes to a different CPU. The threshold S is set in advance according to, for example, the size of the coefficient matrix A. The total count of non-zero elements nₐₗₗ is the sum total of non-zero elements included in the coefficient matrix A.

[Steps S102 and S107] The matrix extending unit 112 repeats steps S103 to S106 while changing the parameter k from 1 to n_{d}. n_{d} is the total number of rows included in the coefficient matrix A.

[Step S103] The matrix extending unit 112 counts the number of non-zero elements in the k^{th} row, nₖ, of the coefficient matrix A.

[Step S104] The matrix extending unit 112 determines whether the number of non-zero elements nₖ counted in step S103 exceeds the threshold S. If the number of non-zero elements nₖ exceeds the threshold S, the processing moves to step S105. On the other hand, the number of non-zero elements nₖ does not exceed the threshold S, the processing moves to step S107, and step S102 and the subsequent steps are then carried out if the parameter k is equal to or below n_{d}.

[Step S105] The matrix extending unit 112 determines the k^{th} row as a large row. The large row is regarded as a row including a great number of non-zero elements and is, therefore, going to be divided.

[Step S106] The matrix extending unit 112 adds nₖ to a parameter n_{c}. The parameter n_{c} is a parameter for counting the sum total of non-zero elements in one or more large rows included in the coefficient matrix A. The process moves to step S107 after the completion of step S106, and step S102 and the subsequent steps are then carried out if the parameter k is equal to or below n_{d}.

[Step S108] The matrix extending unit 112 calculates a large-row division number N_{c}. The large-row division number N_{c} is a parameter indicating into how many row groups the region of the large rows included in the coefficient matrix A is to be divided. For example, if a single large row (the lowermost row in the example of FIG. 7) is present in the coefficient matrix A, as in the case of FIG. 7, the large-row division number N_{c} is obtained by Equation (5) below. nₐ is obtained by subtracting n_{c} from nₐₗₗ. The FLOOR (•) function is used to convert a float into an integer. The FLOOR (•) function rounds a floating-point number passed thereto down to the nearest integer and returns the integer.

Equation (5) is based on a relational expression (4) below. That is, N_{c} is determined in such a manner that the non-zero count obtained by dividing the non-zero elements of the large row into N_{c} groups becomes approximately equal to the non-zero count obtained by dividing non-zero elements included outside of the region of the large row into (N-N_{c}) groups. This technique of determining N_{c} reduces the imbalance in the non-zero count among a plurality of row groups created by dividing the coefficient matrix A.

$$\begin{matrix}\frac{{n}_{a}}{N - {N}_{c}} = \frac{{n}_{c}}{{N}_{c}} & ( 4 ) \\ {N}_{c} = FLOOR ( \frac{{n}_{c}}{{n}_{a} + {n}_{c}} N ) & ( 5 )\end{matrix}$$

Note that how to determine N_{c} when a plurality of large rows are present in the coefficient matrix A is described later.

[Step S109] The matrix extending unit 112 divides the region of one or more large rows included in the coefficient matrix A into N_{c} row groups (matrix extension). For example, in the case where a single large row is present in the coefficient matrix A, the matrix extending unit 112 divides the large row into N_{c} row groups, for example, in the method illustrated in FIG. 7 (in the example of FIG. 7, one large row is divided into two row groups each including one row). In addition, the matrix extending unit 112 extends columns of the coefficient matrix A in such a manner that the coefficient matrix A remains as a symmetric matrix, and also extends the vector {p} included in the matrix-vector multiplication of the coefficient matrix A as well as the vector {q} for storing the results of the matrix-vector multiplication (i.e., the matrix-vector product) (see FIG. 7).

[Step S110] The process assigning unit 113 divides the region of the coefficient matrix A, except for the region of the one or more large rows, into (N-N_{c}) row groups (region division). In the example of FIG. 8, the region of the coefficient matrix A, except for the region of the large row, is divided into Row Groups G1 to G4.

[Step S111] The process assigning unit 113 assigns a process to each of the rows obtained by dividing the large row in step S109, and also assigns a process to each of the row groups obtained by the region division in step S110.

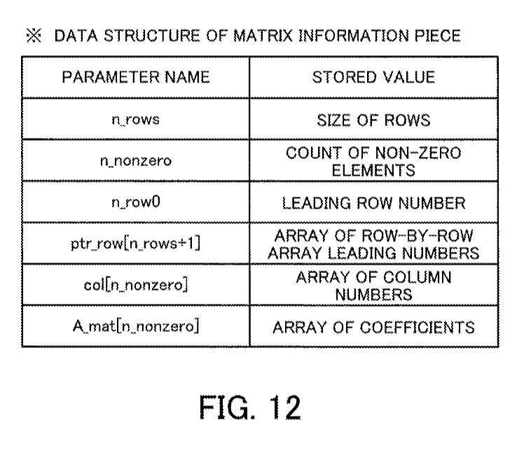

At this point of time, the process assigning unit 113 generates matrix information pieces each having a data structure illustrated in FIG. 12. FIG. 12 illustrates the data structure of a matrix information piece according to the second embodiment. As illustrated in FIG. 12, the matrix information piece stores therein information of parameters indicating the following items: size of rows; count of non-zero elements; leading row number; array of row-by-row array leading numbers; array of column numbers; and array of coefficients.

Matrix information pieces are individually passed on to a corresponding one of CPUs in charge of processes to be executed in parallel. That is, a matrix information piece is generated for each of the processes. The item “size of rows” indicates the size of rows to be handled by the corresponding process in charge (the number of rows included in the corresponding row group). The item “count of non-zero elements” indicates the number of non-zero elements included in the row group to be handled by the process in charge. The item “leading row number” indicates in which row of the coefficient matrix A the beginning of the row group to be handled by the process in charge is located.

The item “array of row-by-row array leading numbers” is an array representing positions within the corresponding array of coefficients, at each of which data of the first one of non-zero elements in each row to be handled by the process in charge is stored. The item “array of column numbers” is an array representing, within the corresponding array of coefficients, columns in which data of non-zero elements in each row to be handled by the process is stored. The item “array of coefficients” is an array representing, within the coefficient matrix A, positions of non-zero elements to be handled by the process. Distributing each of such matrix information pieces to an appropriate process allows for efficient passing of data on non-zero elements, which then contributes to saving memory usage.

[Step S112] The process assigning unit 113 generates communication information pieces used to execute a plurality of processes in parallel, according to details of the assignment of the processes. Once the details of the assignment of the processes are confirmed in step S111, it is determined which CPU is in charge of each of the row groups. Then, it is identified, in order for each CPU to proceed with the computing operation, from which CPU the CPU is going to acquire computational results and to which CPU the CPU is going to provide its computational results. The communication information pieces are information enabling such transmission and reception of computational results among CPUs.

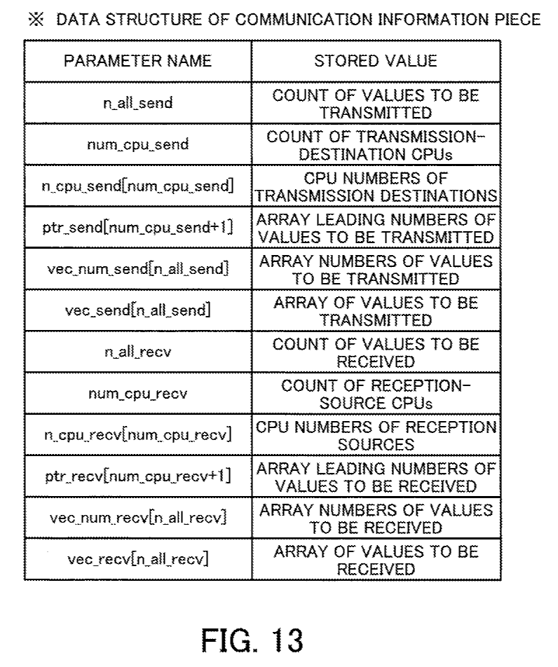

For example, the process assigning unit 113 generates communication information pieces each having a data structure illustrated in FIG. 13. FIG. 13 illustrates the data structure of a communication information piece according to the second embodiment. As illustrated in FIG. 13, the communication information piece includes the following items as information used for transmission: count of values to be transmitted; count of transmission-destination CPUs; CPU numbers of transmission destinations; array leading numbers of values to be transmitted; array numbers of values to be transmitted; and array of values to be transmitted. The communication information piece also includes the following items as information used for reception: count of values to be received; count of reception-source CPUs; CPU numbers of reception sources; array leading numbers of values to be received; array numbers of values to be received; and array of values to be received.

[Step S113] The parallel computing unit 114 carries out transmission and reception of the matrix information pieces generated in step S111 and the communication information pieces generated in step S112. In this regard, a CPU having performed steps S101 to S112 transmits, to each of other CPUs, matrix and communication information pieces corresponding to the CPU, which then receives the transmitted matrix and communication information pieces. That is, matrix and communication information pieces are distributed to CPUs individually in charge of one of processes to be executed in parallel.

[Step S114] The parallel computing unit 114 causes a plurality of CPUs to operate in parallel so that the individual CPUs perform computing operations (calculation of unknowns) of their corresponding row groups based on the matrix information pieces while maintaining cooperation among the CPUs based on the communication information pieces. After the completion of step S114, the series of processing illustrated in FIGS. 10 and 11 ends. The flow of processing has been described thus far.

b-4. Application Example: Magnetic Field Analysis

Next described is an example of applying the technique of the second embodiment to a magnetic field analysis. In the following example, let us assume for the purpose of illustration that CPU #1, CPU #2, . . . , and CPU #10 are available for parallel computation.

Coefficient Matrix

Equations for describing the magnetic field produced by a coil are given as Equations (6) to (8) below using a vector potential A, a current density J, magnetic resistivity ν, interlinkage magnetic flux Φ, resistance R, an electric current I, terminal voltage V, a cross-sectional area of the coil S, and a unit directional vector n of the current density in the coil. As for the left-hand side of Equation (7), the first term represents the induced electromotive force due to temporal change in magnetic flux, and the second term represents a voltage drop due to the resistance.

$$\begin{matrix}∇ \times ( ν ∇ \times α ) = J & ( 6 ) \\ \frac{{d Φ}_{i}}{dt} + {R}_{i} {I}_{i} = {V}_{i} & ( 7 ) \\ J = \frac{1}{S} In & ( 8 )\end{matrix}$$

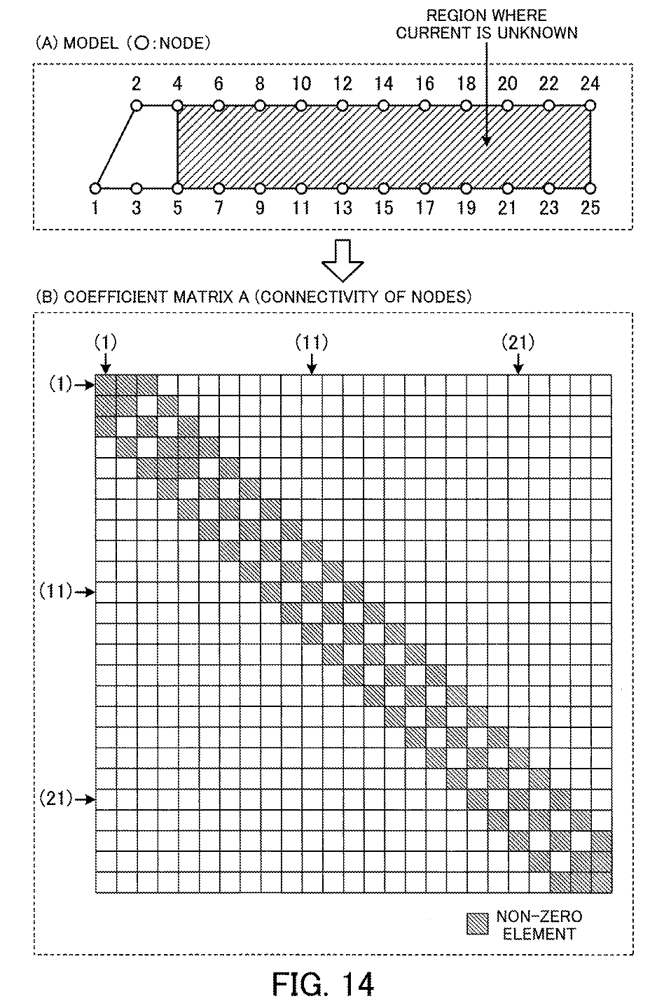

Now let us consider a finite element model where 25 nodes are provided in a rectangular coil and a shaded area is a region where the current is unknown while the remaining area is a region where the current is known, as illustrated in (A) of FIG. 14. In this case, the non-zero pattern of the coefficient matrix A based on the connectivity of the nodes is one illustrated in (B) of FIG. 14. FIG. 14 illustrates how to create a coefficient matrix (connectivity of nodes) according to the application example of the second embodiment. Note that numbers (1), (11), and (21) in (B) of FIG. 14 are row and column numbers given to make the locations of rows and columns to be easily discernible, and correspond to the node numbers.

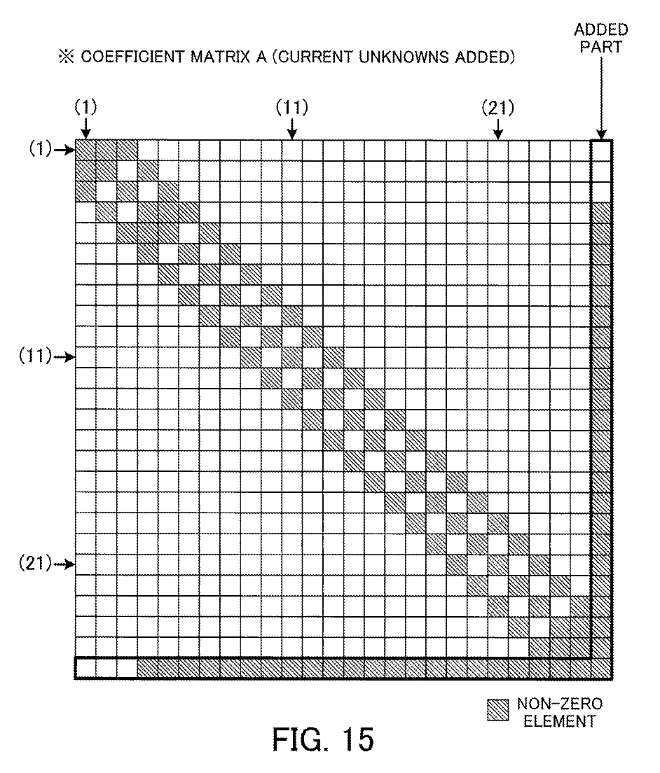

If the current density J is fixed, the coefficient matrix A becomes a band matrix as illustrated in (B) of FIG. 14. On the other hand, if the current density J includes unknowns (current unknowns), the non-zero pattern of the coefficient matrix A becomes one illustrated in FIG. 15. As illustrated in FIG. 15, non-zero elements corresponding to the current unknowns are added as the lowermost row and the rightmost column. According to the finite element model of (A) of FIG. 14, the current values of the nodes 4 to 25 are unknown, and the elements corresponding to the nodes 4 to 25 therefore take non-zero values. FIG. 15 illustrates how to create a coefficient matrix (to which the current unknowns have been added) according to the application example of the second embodiment.

Matrix Extension and Region Division

In the case where the threshold S is 10, the row corresponding to the current unknowns becomes a large row. If the parallel process count N is 10, the large-row division number N_{c} is obtained by Equations (9) and (10) below based on the above-cited Equations (4) and (5). The large-row division number N_{c} is 2 according to the result of Equation (10). On the other hand, the division number of the region except for the region of the large row, (N-N_{c}), is 8. Note that ROUND(•) is a function for rounding off a value passed thereto, and MOD(•) is a function for outputting the reminder.

$$\begin{matrix}{N}_{c} = \frac{{n}_{c}}{{n}_{a} + {n}_{c}} N = \frac{23}{97 + 23} \times 10 = 1.917 & ( 9 ) \\ \begin{matrix}{N}_{c} = FLOOR ( {N}_{c} ) + ROUND ( MOD ( {N}_{c} ) ) \\ = 1 + ROUND ( 0.917 ) \\ = 1 + 1 \\ = 2\end{matrix} & ( 10 )\end{matrix}$$

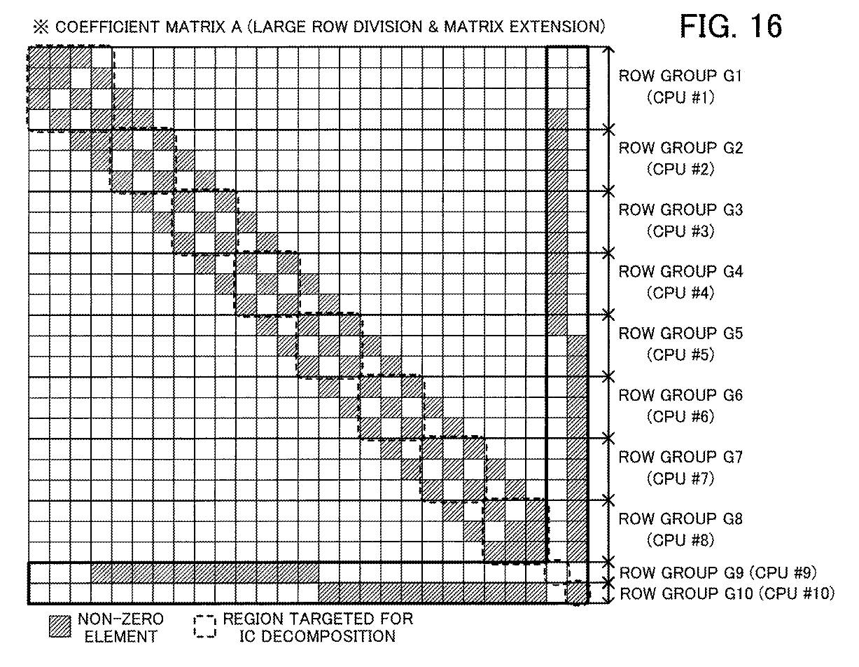

By dividing the large row into two and dividing the remaining rows into eight row groups, the coefficient matrix A illustrated in FIG. 16 is obtained. FIG. 16 illustrates an example of the matrix extension method and the region division method according to the application example of the second embodiment. The row groups are configured in such a manner that each of the row groups includes more or less the same number of non-zero elements. Note that a region surrounded by the dashed line in FIG. 16 is targeted for the incomplete Cholesky decomposition. Processes are then individually assigned to each of the configured row groups, and CPUs for executing the assigned processes are associated one-to-one with the row groups. In the example of FIG. 16, CPUs #1, #2, . . . , and #10 are associated with Row Groups G1, G2, . . . , and G10, respectively.

Communication and Matrix Information Pieces

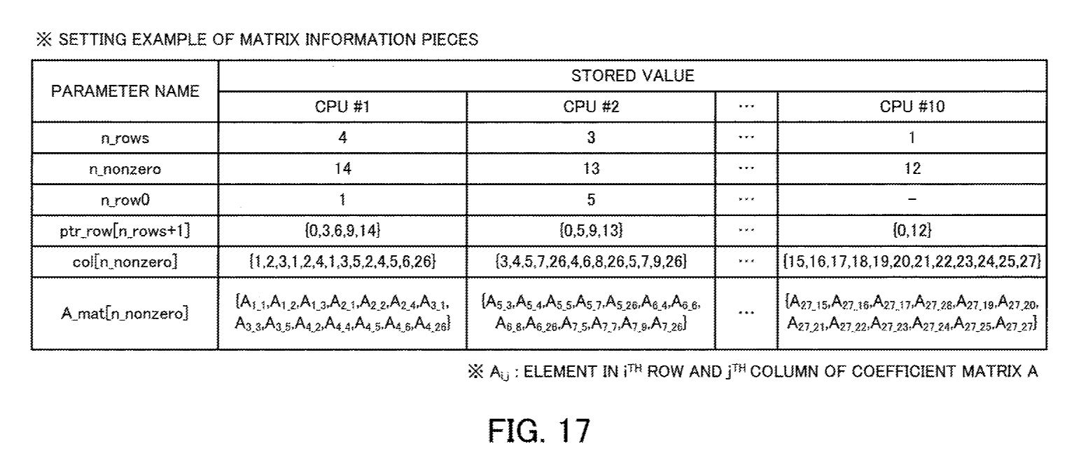

When the extension of the coefficient matrix A and the process assignment are completed as illustrated in FIG. 16, it is possible to set matrix information pieces as illustrated in FIG. 17. FIG. 17 illustrates a setting example of matrix information pieces according to the application example of the second embodiment. As illustrated in FIG. 17, a matrix information piece is set for each CPU to execute a process. In the example of FIG. 17, for CPU #1 in charge of Row Group G1, the size of rows (n_rows) is set to 4; the count of non-zero elements (n_nonzero) is set to 14; and the leading row number (n_row 0) is set to 1. In addition, the array of row-by-row array leading numbers (ptr_row[]), the array of column numbers (col[]), and the array of coefficients (A_mat[]) are also set. Note that Aᵢ_{_}^{j} represents the element in the i^{th} row and j^{th} column of the coefficient matrix A. As for CPUs ∩2 to #10 also, the parameters are set according to the assignment details illustrated in FIG. 16.

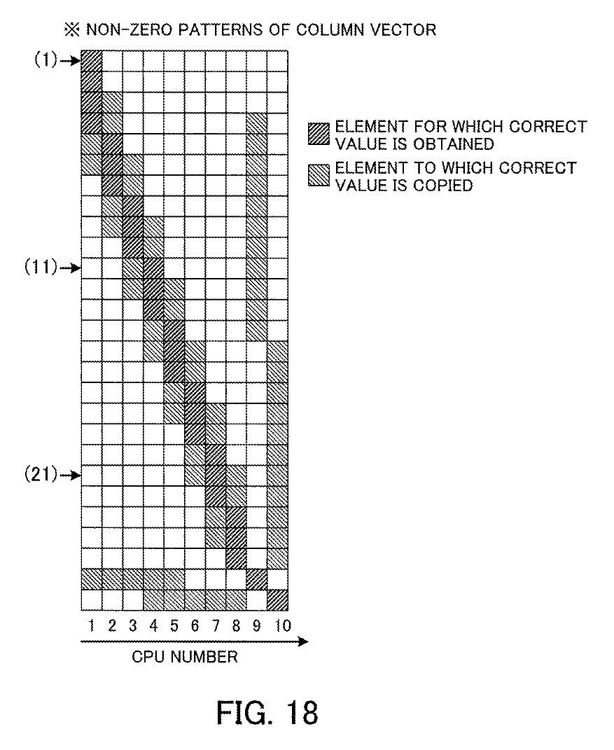

Once the assignment details of FIG. 16 are determined, elements of the column vectors (the vectors {p} and {q}) for which each CPU is able to obtain correct values by its own computation are identified. For example, based on the non-zero pattern of the coefficient matrix A (after the extension) of FIG. 16, the non-zero pattern (hatched part) of a column vector is identified for each CPU, as illustrated in FIG. 18. FIG. 18 illustrates non-zero patterns of the column vector for the individual CPUs according to the application example of the second embodiment.

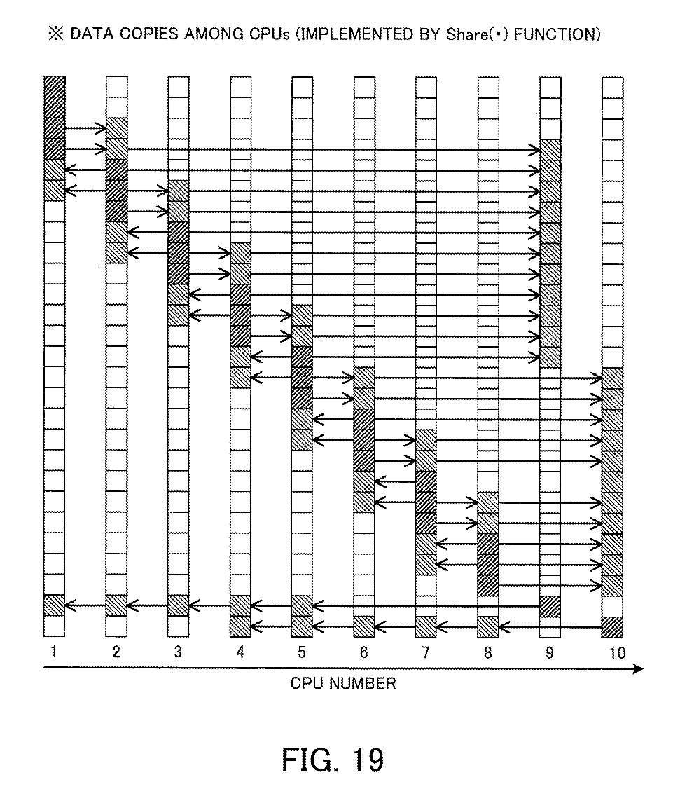

In addition, based on the assignment details of FIG. 16, it is possible to identify elements for which each CPU is able or not able to obtain correct values by its own computation (darker hatched elements representing those for which correct values are obtained, and lighter hatched elements representing those for which correct values are not obtained). As for the elements for which the CPU is not able to obtain correct values, correct values that other CPUs have obtained by their computing operations (computational results) are copied thereto, as indicated by the arrows in FIG. 19. FIG. 19 illustrates data copies among the CPUs according to the application example of the second embodiment.

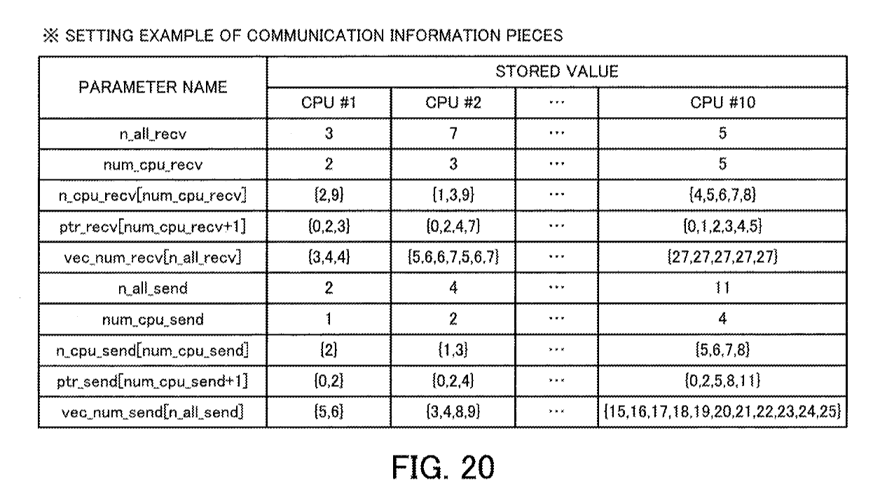

Once data of the computational results transmitted and received among the CPUs and sources and destinations of the data transmission are identified, as illustrated in FIG. 19, it is possible to set communication information pieces as illustrated in FIG. 20. FIG. 20 illustrates a setting example of communication information pieces according to the application example of the second embodiment. In the example of FIG. 20, as a communication information piece provided to CPU #1, the count of values to be transmitted (n_all_send) is set to 2; the count of transmission-destination CPUs (num_cpu_send) is set to 1; the count of values to be received (n_all_recv) is set to 3; and the count of reception-source CPUs (num_cpu_recv) is set to 2. In addition, the array leading numbers of values to be transmitted (ptr_send[]), the array numbers of values to be transmitted (vec_num_send[]), and the array of values to be transmitted (vec_send[]) are also set.

With reference to FIG. 19, CPU #1 transmits the values of the third and fourth elements from the top to CPU #2. Therefore, the count of values to be transmitted is set to 2, and the count of transmission-destination CPUs is set to 1. CPU #1 is not able to obtain, among column vector elements to be used in its own computing operation (non-zero elements), correct values for the fifth, sixth, and twenty-sixth elements. Therefore, CPU #1 receives the values of the fifth and sixth elements from CPU #2, and receives the value of the twenty-sixth element from CPU #10. Therefore, the count of values to be received is set to 3, and the count of reception-source CPUs is set to 2. The same rule applies to the remaining CPUs.

### PROGRAM CODE EXAMPLE #1

### Share Function

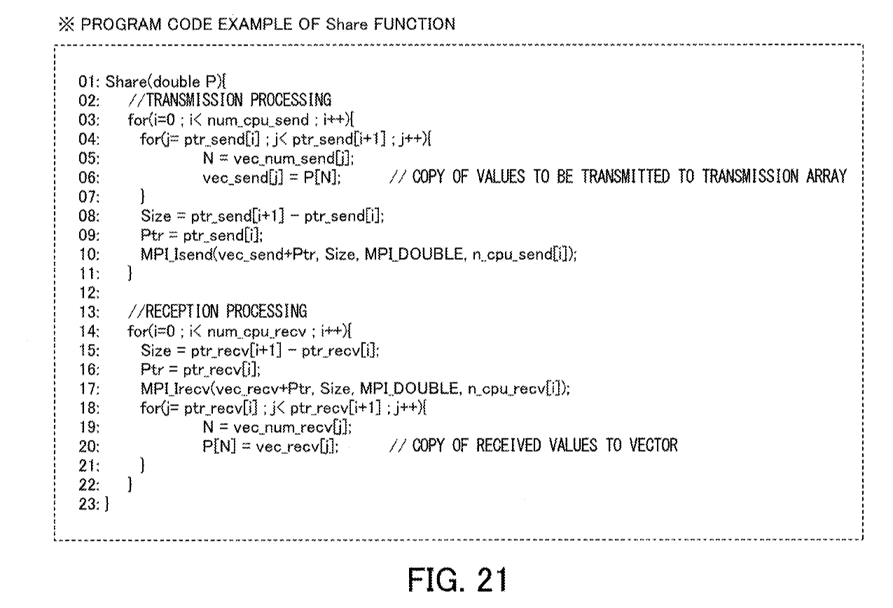

The CPUs after obtaining the above-cited communication information pieces executes a program code illustrated in FIG. 21 to exchange the computational results. FIG. 21 illustrates a program code example of the Share function according to the second embodiment. In the example of FIG. 21, the program code is written in C language. Lines 3 to 11 correspond to transmission processing, and Lines 14 to 22 correspond to reception processing.

As for the transmission processing, in Lines 4 to 7, values to be transmitted are copied to a transmission array, and in Line 10, data of the array is transmitted to another CPU using the MPI function. As for the reception processing, in Line 17, data of an array is received from another CPU using the MPI function, and in Lines 18 to 20, received values are copied to a vector used for the computing operation of the recipient CPU. Data is transmitted and received using the Share (•) function.

### PROGRAM CODE EXAMPLE #2

### Reduce_Sum

In implementing the above-described matrix extension, the column vectors are also extended along with the extension of the coefficient matrix A. In this regard, the column vector element (Q) for storing a component of the matrix-vector product corresponding to the large row is divided. Therefore, a step of restoring the element is incorporated in the computing operation. The Reduce sum function is used to perform the step of restoring the element.

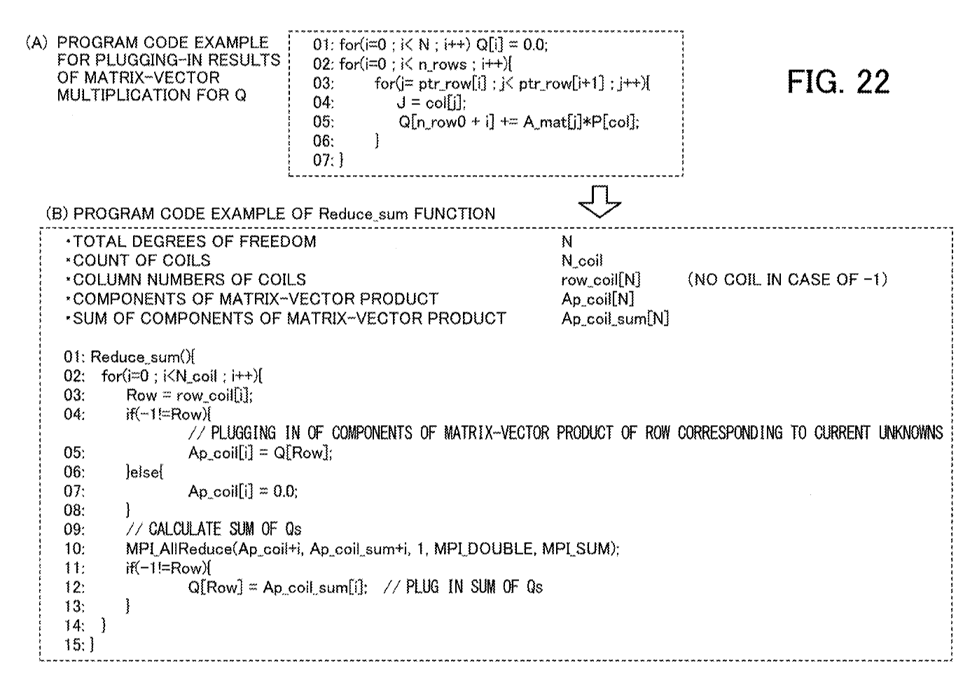

Prior to executing the Reduce sum function, a program code illustrated in (A) of FIG. 22 is executed to plug, into an array (Q []), computational results of the matrix-vector multiplication individually corresponding to each of the rows obtained by dividing the large row. Subsequently, a program code of the Reduce sum function illustrated in (B) of FIG. 22 is executed to calculate the sum of the array. FIG. 22 illustrates a program code example for plugging in the results of the matrix-vector multiplication and a program code example of the Reduce_sum function according to the second embodiment. Note that, in the example of FIG. 22, the codes are written in C language.

Advantageous Effect: Scalability of Parallel Processing

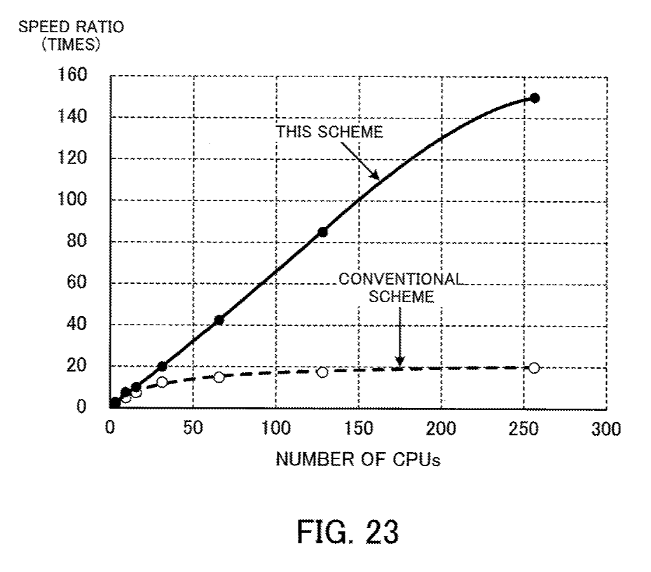

The application of the technique of the second embodiment described thus far achieves high parallel scalability as illustrated in FIG. 23 (this scheme). FIG. 23 illustrates evaluation results of parallel scalability achieved by applying the technique of the second embodiment. FIG. 23 also includes evaluation results of a conventional scheme for comparison. In the case of the conventional scheme, an increase in the speed ratio associated with an increase in the number of CPUs begins to plateau just after the number of CPUs exceeds 150. On the other hand, in the case of this scheme (i.e., in the case of applying the technique of the second embodiment), the speed ratio relative to an increase in the number of CPUs continues to increase even when the number of CPUs exceeds 250. Thus, the application of the technique of the second embodiment improves the parallel scalability.

Supplementary Note: Case of a Plurality of Coils

The above-described application example is directed to the scheme for analyzing a magnetic field produced by one coil to which a terminal voltage is applied. In the above description, the number of coils is set to one for the purpose of illustration; however, the technique of the second embodiment may also be applied to, for example, an inductor model composed of a plurality of coils wound around a core. In this case, a plurality of large rows corresponding to the plurality of coils are included in the coefficient matrix A. Therefore, the procedure for calculating the large-row division number N_{c} is extended as represented by Equations (11) to (15) below.

The degrees of freedom of all the coils n_{c}_{_}^{all} are obtained by Equation (11) below where y_{coil} is the number of coils and n_{cy} is the degrees of freedom associated with the y^{th} coil (total unknowns). In addition, based on Equation (12), the large-row division number N_{c} is obtained by Equation (13). Further, the division number of each large row N_{cy} (the number of divisions of a large row corresponding to the y^{th} coil) is obtained by Equation (14).

Note that the average degrees of freedom of the coils assigned to one process <n_{c}>is obtained by Equation (15). If n_{cy} is less than <n_{c}>, N_{cy} becomes 0. In this case, large rows corresponding to two or more coils are grouped together so that at least one process is assigned to the large row group. For example, the process assigning unit 113 rearranges the numbers of coils in ascending order of n_{cy} (n_{cy}<n_{c(y+1)}) (corresponding to the order of the large rows), and groups large rows whose N_{cy} is less than 1 together. In this regard, the process assigning unit 113 forms the group by combining large rows in such a manner that the value obtained by summing the division numbers of all the grouped large rows exceeds 1.

$$\begin{matrix}{n}_{c \_ all} = {\sum }_{y = 1}^{{y}_{coil}} {n}_{cy} & ( 11 ) \\ \frac{{n}_{a}}{N - {N}_{c}} = \frac{{n}_{c \_ all}}{{N}_{c}} & ( 12 ) \\ {N}_{c} = FLOOR ( \frac{{n}_{c \_ all}}{{n}_{a} + {n}_{c \_ all}} N ) & ( 13 ) \\ {N}_{cy} = FLOOR ( \frac{{n}_{cy}}{{n}_{a} + {n}_{c \_ all}} N ) & ( 14 ) \\ 〈 {n}_{c} 〉 = \frac{{n}_{c \_ all}}{{N}_{c}} & ( 15 )\end{matrix}$$

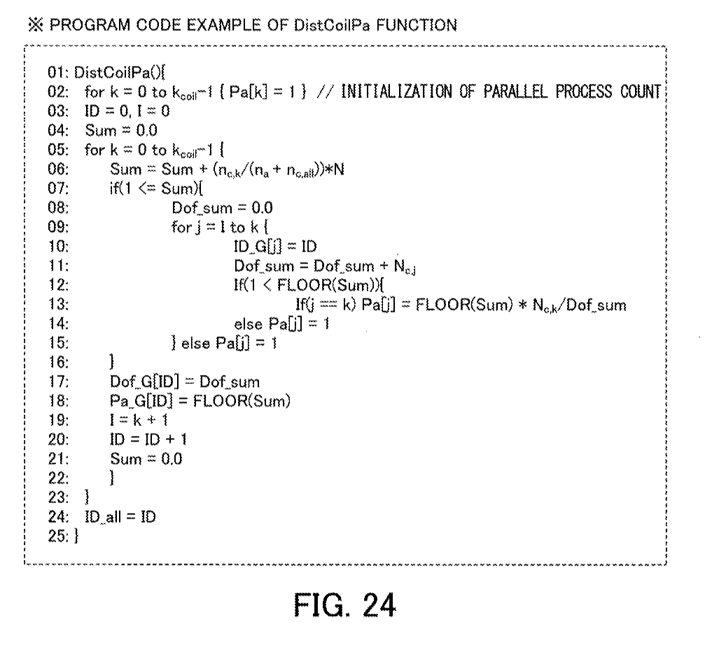

When the identification number of each group is denoted by ID_G, the division number of each group is denoted by Pa_G, the degrees of freedom of each group is denoted by Dof_G, and the division number of each large row is denoted by Pa, these values are calculated using the program code (the DistCoilPa(•) function) illustrated in FIG. 24. FIG. 24 illustrates a program code example of the DistCoilPa function according to the second embodiment. Each of ID_G, Pa_G, Dof_G, and Pa is output in the form of an array.

If the division number of each group is 1, the process assigning unit 113 does not divide the corresponding large row or rows. If the division number of each group is larger than 1 and the group includes one large row, the process assigning unit 113 divides the large row by the corresponding division number Pa. If the division number of each group is larger than 1 and the group includes more than one large row, the process assigning unit 113 considers that the division number exceeded 1 when the last large row was added to the group. Then, the process assigning unit 113 divides only the last large row of the group by the division number.

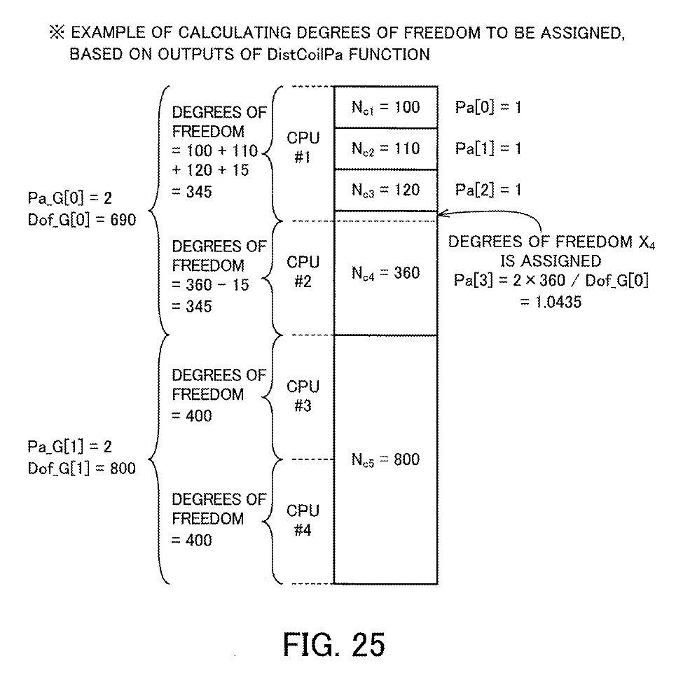

An example of assigning four CPUs #1 to #4 to five large rows (corresponding to five coils) is illustrated in FIG. 25. FIG. 25 illustrates an example of calculating the degrees of freedom assigned, based on the outputs of the DistCoilPa function according to the second embodiment. Execution of the DistCoilPa function of FIG. 24 yields Pa_G and Pa. In the example of FIG. 25, the five large rows are placed into two large groups (groups individually corresponding to Pa_G[0] and Pa_G[1]), and the CPUs are assigned to the large rows according to their degrees of freedom.

Note that, in order to adjust the degrees of freedom, a part of the degrees of freedom corresponding to the fourth coil, X₄, is assigned to CPU #1. The degrees of freedom X₄ are calculated by Equation (16) below. MOD(•) is a function for calculating the reminder. By placing a plurality of large rows corresponding to a plurality of coils into one group and assigning a process to each group as illustrated in FIG. 25, it is possible to flexibly apply the technique of the second embodiment to such a model including a plurality of coils.

$$\begin{matrix}{X}_{4} = FLOOR ( Dof \_ G [ 0 ] \times \frac{MOD ( Pa [ 3 ] )}{Pa\_G [ 0 ]} ) \\ = FLOOR ( 690 \times 0.0435 / 2 ) \\ = 15\end{matrix} \qquad ( 16 )$$

The second embodiment has been described thus far.

According to an aspect, it is possible to improve the scalability of parallel processing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention.

Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a matrix computing program that causes a processor of a computer including a memory and the processor and performing processing for computing a matrix equation that includes a sparse matrix as a coefficient matrix to perform a procedure comprising:
acquiring, from the memory, a threshold used to determine multitude of non-zero elements included in each of rows of the sparse matrix;
identifying, within the sparse matrix, a first row whose count of the non-zero elements is larger than the threshold;
extending the sparse matrix by dividing the identified first row into a plurality of second rows; and
dividing the extended sparse matrix into a plurality of row groups and assigning a process being an executable unit of the processing to each of the row groups.

2. The non-transitory computer-readable storage medium according to claim 1, wherein:
the dividing the extended sparse matrix includes dividing the second rows into the row groups and dividing the rows of the sparse matrix, except for the second rows, into the row groups.

3. The non-transitory computer-readable storage medium according to claim 1, wherein:
the dividing the extended sparse matrix includes determining a combination of rows to be included in each of the row groups according to a count of the non-zero elements included in the row group.

4. The non-transitory computer-readable storage medium according to claim 1, wherein:
the extending the sparse matrix includes determining a number of the second rows according to the count of the non-zero elements included in the first row.

5. A matrix division method used by a computer including a memory and a processor and performing processing for computing a matrix equation that includes a sparse matrix as a coefficient matrix, the matrix division method comprising:
acquiring, by the processor, from the memory, a threshold used to determine multitude of non-zero elements included in each of rows of the sparse matrix;
identifying, by the processor, within the sparse matrix, a first row whose count of the non-zero elements is larger than the threshold;
extending, by the processor, the sparse matrix by dividing the identified first row into a plurality of second rows; and
dividing, by the processor, the extended sparse matrix into a plurality of row groups and assigning a process being an executable unit of the processing to each of the row groups.

6. A parallel processing apparatus for performing processing for computing a matrix equation that includes a sparse matrix as a coefficient matrix, the parallel processing apparatus comprising:
a plurality of processors configured to run, in parallel, a plurality of processes each being an executable unit of the processing; and
a memory configured to store a threshold used to determine multitude of non-zero elements included in each of rows of the sparse matrix,
wherein a processor among the processors
identifies, within the sparse matrix, a first row whose count of the non-zero elements is larger than the threshold,
extending the sparse matrix by dividing the identified first row into a plurality of second rows,
dividing the extended sparse matrix into a plurality of row groups, and
assigning the processes respectively to the row groups.
